(19) United States
(12) Patent Application Publication
(10) Pub. No.: US 2011/0307819 A1
(43) Pub. Date: Dec. 15, 2011

(54) NAVIGATING DOMINANT CONCEPTS EXTRACTED FROM MULTIPLE SOURCES

(75) Inventors: VISWANATH VADLAMANI, REDMOND, WA (US); TAREK NAJM, KIRKLAND, WA (US)

(73) Assignee: MICROSOFT CORPORATION, REDMOND, WA (US)

(21) Appl. No.: 12/797,375

(22) Filed: Jun. 9, 2010

(51) Int. Cl. G06F 3/048; G06F 17/30

(52) U.S. Cl. 715/771; 707/706; 707/E17.014; 715/809

(57) ABSTRACT

Graphical user interfaces, methods, and computer-storage media for navigating dominant concepts are provided. The method is executed by a computer system that generates a graphical user interface having dominant concepts associated with a contextual query. The contextual query is issued to a search engine that searches multiple sources to locate results. The computer system extracts the dominant concepts from the results. In turn, a graph is added to the graphical user interface to group the dominant concepts. The graph links the contextual query and the dominant concepts and provides controls that dynamically alter dominant concepts displayed by the graphical user interface. The graphical user interface and the dominant concepts displayed are updated based on control manipulations.

### CROSS-REFERENCE TO RELATED APPLICATIONS

This application is related to application Ser. No. 12/700,980, filed 5 Feb. 2010 (Attorney Docket No. 328616.01/MFCP.153202), entitled “Generating and Presenting Lateral Concepts”; and application Ser. No. 12/795,238, filed 7 Jun. 2010 (Attorney Docket No. 329670.01/MFCP.154856), entitled “Identifying Dominant Concepts Across Multiple Sources”, and which are incorporated by reference herein.

### BACKGROUND

Conventional search engines receive queries from users and locate web pages having terms that match the terms included in the received queries. Conventionally, the search engines ignore the context and meaning of the user query and treat the query as a set of words. The terms included in the query are searched for based on frequency, and results that include the terms of the query are returned by the search engine. Accordingly, conventional search engines return results that might fail to satisfy the interests of the user.

The conventional search engines may display a set of popular terms that a user may employ to formulate a query. The popular terms are words that users provide the search engine when searching for an item. The popular terms may be displayed in a hot topics section on a web page for the search engine. A user may click on the popular terms listed in the hot topics section to issue a query with the selected popular term.

Some conventional search engines also display tag clouds that list terms that reoccur across all items on a network, such as the Internet. The tag clouds provide a snapshot of the words that are being used within items available on the Internet. The terms in the tag cloud may be displayed in a cluster on a web page for the search engine. And a user may click on the terms listed in the tag cloud to issue a query with the selected term.

Unfortunately, the conventional search engines fail to provide a broad overview of the major concepts that are encapsulated within the results provided in response to a user's query. Rather, in response to the user's query the conventional search engines return a collection of items that include the terms of the query. The user must then peruse the collection to determine the broad concepts represented in the collection of documents.

### SUMMARY

Embodiments of the invention relate to systems, methods, and computer-readable media for generating a graph for dominant concepts and navigating dominant concepts extracted from multiple sources. The dominant concepts are extracted from results generated by a search engine that received a contextual query. The dominant concepts are displayed to provide a broad overview of major concepts encapsulated within the results.

A computer system executes a computer-implemented method to navigate the dominant concepts. The computer system generates a graphical user interface for the dominant concepts. The graphical user interface includes a results portion that clusters results that match a contextual query from the various sources. The graphical user interface also includes a graph control that links the contextual query and dominant concepts extracted from the search results for the contextual query. The graph control includes navigation operations and view operations. The navigation operations update the graphical user interface to view graph controls for prior contextual queries or additional dominant concepts for a selected contextual query. The view operations provide attribute information for the dominant concepts or the contextual queries. The view operations may also provide additional dominant concepts that are related to the dominant concepts displayed in the graph control.

This summary is provided to introduce a selection of concepts in a simplified form that are further described below in the detailed description. This summary is not intended to identify key features or essential features of the claimed subject matter, nor is it intended to be used as an aid in isolation to determine the scope of the claimed subject matter.

### BRIEF DESCRIPTION OF THE DRAWINGS

Illustrative embodiments of the invention are described in detail below with reference to the attached drawing figures, which are incorporated by reference herein, wherein:

FIG. 1 is a block diagram illustrating an exemplary computing device in accordance with embodiments of the invention;

FIG. 2 is a screenshot illustrating a graphical user interface displaying a sparkler having dominant concepts in accordance with embodiments of the invention;

FIG. 3 is a screenshot illustrating an operations dialog box for the dominant concepts in accordance with embodiments of the invention;

FIG. 4 is another screenshot illustrating a graphical user interface displaying dominant concepts along with search results in accordance with embodiments of the invention;

FIG. 5 is another screenshot illustrating a graphical user interface transitioning dominant concepts and search results in accordance with embodiments of the invention; and

FIG. 6 is a logic diagram illustrating a computer-implemented method for navigating dominant concepts in accordance with embodiments of the invention.

### DETAILED DESCRIPTION

This patent describes the subject matter for patenting with specificity to satisfy statutory requirements. However, the description itself is not intended to limit the scope of this patent. Rather, the inventors have contemplated that the claimed subject matter might also be embodied in other ways, to include different steps or combinations of steps similar to the ones described in this patent, in conjunction with other present or future technologies. Moreover, although the terms “step” and “block” may be used herein to connote different elements of methods employed, the terms should not be interpreted as implying any particular order among or between various elements herein described unless and except when the order of individual elements is explicitly described.

As used herein the term “component” refers to any combination of hardware, firmware, and software.

Embodiments of the invention provide a graphical user interface that displays dominant concepts extracted from results associated with contextual queries received by a search engine. In one embodiment, dominant concepts in a corpus of documents included in the results are ranked and displayed to a user. The corpus of documents includes items from various sources searched by the search engine in response to the contextual queries. Relationships between the dominant concepts and the contextual queries are prioritized based on support from the corpus of documents. A user may explore the dominant concepts and snippets of documents that support the relationships between the dominant concepts and the contextual queries. Moreover, dominant concepts may be used as query terms in the search engine by clicking on the displayed dominant concepts. The graphical user interface that displays the dominant concepts may include a history view that displays recent dominant concepts accessed by the user or recent contextual queries formulated by the user. The graphical user interface also includes navigation controls to traverse a graph control that links the dominant concepts and contextual queries.

In some embodiments, the dominant concepts within the corpus of documents may be navigated with a graph control, such as a sparkler. The sparkler may be a graphical representation of a star that includes multiple spokes. One spoke may represent the contextual query and the other spokes may represent the dominant concepts. In certain embodiments, the sparkler has a limited number of spokes. The limit on the number of spokes increases readability of the dominant concepts and the contextual queries displayed as part of the sparkler. In one embodiment, the sparkler is limited to 5 spokes. The dominant concepts displayed on the sparkler are among the highest ranked dominant concepts. Accordingly, the sparkler allows a user to quickly understand the important concepts within results corresponding to the contextual query.

For instance, a search engine may provide results in response to a contextual query for “popular artist A.” The contextual query may include, among other things, the location of the user, the date the query was formulated by the user, and the application that was used to formulate the query. The results of the search engine are further processed to identify dominant concepts and relationships between the dominant concepts and the query terms. The dominant concepts for the “popular artist A” may include, but are not limited to, “popular artist B,” award events, and concert events. These dominant concepts are ranked based on distances provided by a metabase having the dominant concepts and the contextual queries. In turn, the dominant concepts with the highest ranks are selected for display on a graphical user interface with the contextual queries. The graphical user interface may display “popular artist A,” “popular artist B,” and award events on the sparkler.

The user may navigate the sparkler with a mouse or any other pointing device. When the user hovers on the “popular artist B” dominant concept, a dialog box is displayed to the user. The dialog box provides an option to issue a contextual query using the dominant concept “popular artist B” or an option to explore the relationships between the dominant concept “popular artist B” and the contextual query “popular artist A.” If the user selects the option to issue a contextual query, “popular artist B” is transmitted to the search engine for new search results. If the user selects the option to explore the dominant concept, relationships that include snippets supporting the link between “popular artist B” and “popular artist A” are displayed in priority order. The snippets may state “popular artist A and popular artist B perform in Germany,” “popular artist A and popular artist B support charity,” or “popular artist A ten spots ahead of popular artist B in top 100 singers.”

The search engine receives query terms from a user. Also, the search engine receives contexts for one or more applications that provide the queries during the current search session. The contexts and query terms are context attributes that specify a contextual query. Various data sources are searched to locate results that match to the contextual queries. The results are further processed by an entity extractor to identify entities represented in the results. In some embodiments, the entities are nouns. The extracted entities are ranked and identified as dominant concepts when a distance between the extracted entities and the contextual query is below a specified threshold.

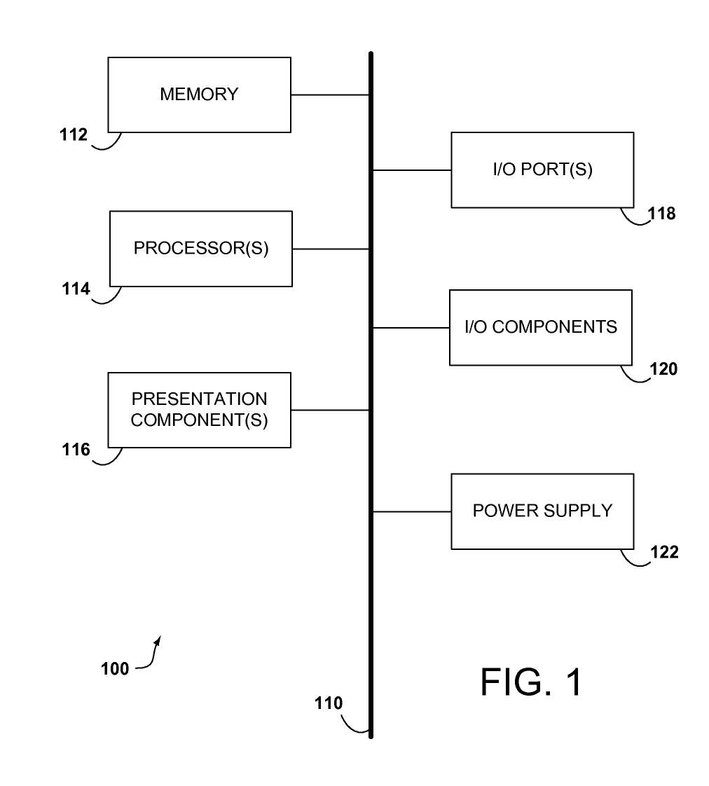

FIG. 1 is a block diagram illustrating an exemplary computing device in accordance with embodiments of the invention. The computing device 100 includes bus 110, memory 112, processors 114, presentation components 116, input/output (I/O) ports 118, input/output (I/o) components 120, and a power supply 122. The computing device 100 is but one example of a suitable computing environment and is not intended to suggest any limitation as to the scope of use or functionality of the embodiments of the invention. Neither should the computing device 100 be interpreted as having any dependency or requirement relating to any one or combination of components illustrated.

The computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that may be used to encode desired information and be accessed by the computing device 100. Embodiments of the invention may be implemented using computer code or machine-useable instructions, including computer-executable instructions such as program modules, being executed by a computing device 100, such as a personal data assistant, gaming device, or other handheld device. Generally, program modules including routines, programs, objects, modules, data structures, and the like, refer to code that performs particular tasks or implements particular abstract data types. Embodiments of the invention may be practiced in a variety of system configurations, including distributed computing environments where tasks are performed by remote-processing devices that are linked through a communications network.

The computing device 100 includes a bus 110 that directly or indirectly couples the following components: memory 112, one or more processors 114, one or more presentation components 116, input/output (I/O) ports 118, I/O components 120, and power supply 122. The bus 110 represents what may be one or more busses (such as an address bus, data bus, or combination thereof). Although the various components of FIG. 1 are shown with lines for the sake of clarity, in reality, delineating various modules is not so clear, and metaphorically, the lines would more accurately be grey and fuzzy. For example, one may consider a presentation component 116 such as a display device to be an I/O component. Also, processors 114 have memory 112. Distinction is not made between “workstation,” “server,” “laptop,” “handheld device,” etc., as all are contemplated within the scope of FIG. 1.

The memory 112 includes computer-readable media and computer-storage media in the form of volatile and/or nonvolatile memory. The memory may be removable, nonremovable, or a combination thereof. Exemplary memory hardware includes, but is not limited to, solid-state memory, hard drives, optical-disc drives, etc. The computing device 100 includes one or more processors 114 that read data from various entities such as the memory 112 or I/O components 120. The presentation components 116 present data indications to a user or other device. Exemplary presentation components 116 include a display device, speaker, printer, vibrating module, and the like. The I/O ports 118 allow the computing device 100 to be physically and logically coupled to other devices including the I/O components 120, some of which may be built in. Illustrative I/O components 120 include a microphone, joystick, game pad, satellite dish, scanner, printer, wireless device, and the like.

In some embodiments, a computer system identifies dominant concepts and relationships between the identified dominant concepts and a contextual query. The computer system includes a search engine connected to various sources, an entity extraction component, a metabase, and a ranking component. The search engine receives a contextual query and provides results in response to the contextual query. The entity extraction component parses the results and identifies entities included in the results. The metabase provides a distance between the entities included in the results and the query terms included in the contextual query. The ranking component ranks the entities based on the distance provided by the metabase and selects dominant concepts within the results based on the ranks assigned to entities. In turn, relationships between the dominant concepts and contextual queries, where the relationships include snippets that support the link between the dominant concepts and contextual queries are made available for navigation by the user via a graph control like a sparkler. In other embodiments, the graph control may be a cluster or any other aggregation of similar items.

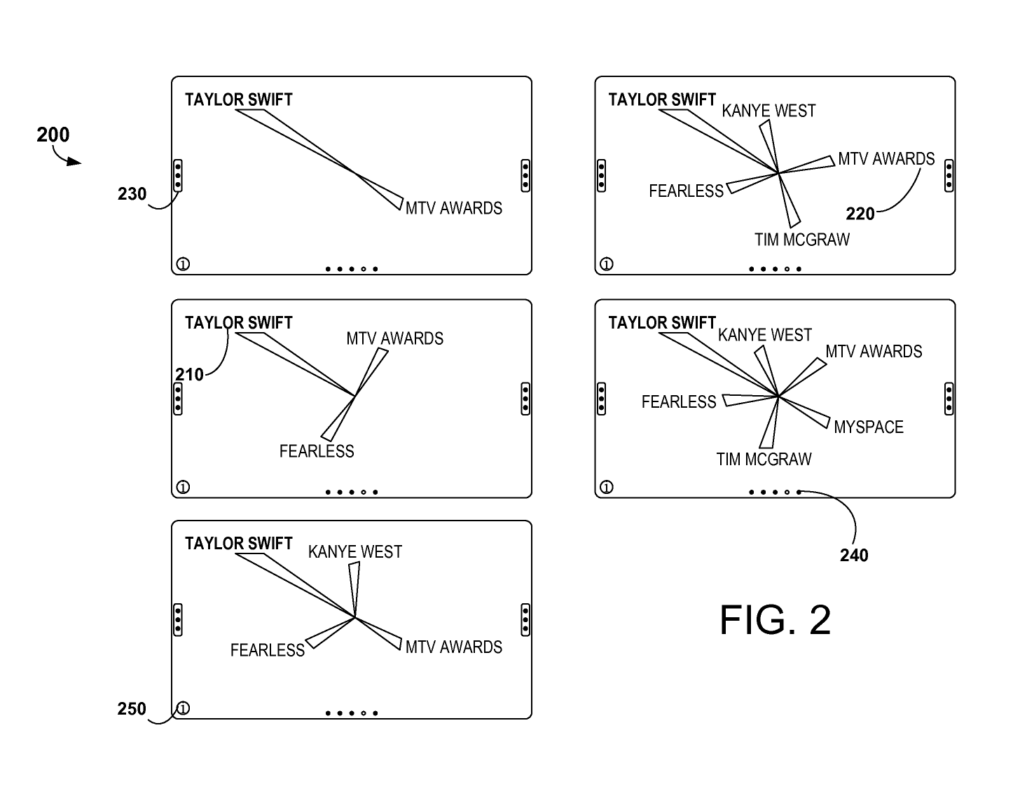

FIG. 2 is a screenshot illustrating a graphical user interface 200 displaying a sparkler having dominant concepts in accordance with embodiments of the invention. The graphical user interface 200 includes a contextual query 210, dominant concepts 220, backward and forward navigation controls 230, history navigation controls 240, and dominant concept operation controls 250.

The contextual query 210 is displayed on the sparkler along with dominant concepts 220. The contextual query includes the query term received from the search engine. In an embodiment, the computer system may generate a graphical user interface 200 where the contextual query is highlighted or bolded. The graphical user interface may also include dominant concepts 220 that have neutral formatting. The contextual query 210 may be a link to a view that displays search results for the selected, i.e. clicked-on, contextual query 210 and a graph control, such as a sparkler for the contextual query 210.

The dominant concepts 220 are the terms extracted from the search results for the contextual query. The dominant concepts 220 provide an overview of important concepts included in the search results. The graphical user interface 200 includes multiple dominant concepts 220 for the contextual query. The dominant concepts 220 may be a link to a view that displays the search results for the selected, i.e. clicked-on, dominant concept 220 and a graph control, such as a sparkler for the dominant concept 220 that is now selected as a contextual query 210.

For instance, “TAYLOR SWIFT” may be a contextual query 210 and dominant concepts found for the search results for “TAYLOR SWIFT” may include “MTV AWARDS,” KANYE WEST,” “FEARLESS,” and “TIM MCGRAW.” The graphical user interface may include these concepts and allows the user to navigate and perform operations on them.

The backward and forward navigation controls 230 allow the user to view additional dominant concepts 220 that may be related to the contextual query 210. The user may click on the backward navigation control 230 to see previously viewed dominant concepts. Additionally, the user may click on the forward navigation control 230 to see additional dominant concepts that were not previously viewed. In one embodiment, backward and forward navigation controls 230 may be clicked on and held to initiate an animation that transitions the view. For instance, a forward navigation transitioning the view from left-to-right occurs when a user holds the pointer at the backward and forward navigation controls 230 and moves the pointer from left-to-right. A backward navigation transitioning the view from right-to-left occurs when a user holds the backward and forward navigation controls 230 and moves the pointer from right-to-left.

The history navigation controls 240 allow the user to view previously issued contextual queries 210. In one embodiment, the history navigation control 240 is a set of ellipsis located at the bottom of the graph presented in the graphical user interface 200. Each ellipsis is a history navigation control 240 that represents a separate contextual query 210 whose results were reviewed as a sparkler by the user. A user may click on a history navigation control 240 to navigate to a view that illustrates a previously viewed contextual query 210 and its corresponding dominant concepts 220. In one embodiment, the previously viewed contextual query 210 and its corresponding dominant concepts 220 are displayed in a graph control, such as a sparkler.

The dominant concept operation controls 250 allow the user to view operations that may be performed to dynamically alter the graphical user interface 200. The dominant concept operation control may be an “i” icon located on the graphical user interface 200. When the icon is selected by the user a dialog box is generated to provide a list of operations, such as, but not limited to, attribute list, nearest neighbor, etc.

In some embodiments, the dominant concepts are displayed in a graphical user interface to provide an overview of the important concepts included in results returned by a search engine in response to a contextual query. The graphical user interface may present a sparkler that is navigable to review prior contextual queries and corresponding dominant concepts. The user may use a mouse or pointer to click on, or hover over, the dominant concepts. The user may also perform a number of operations on the dominant concepts and contextual query displayed in the graphical user interface.

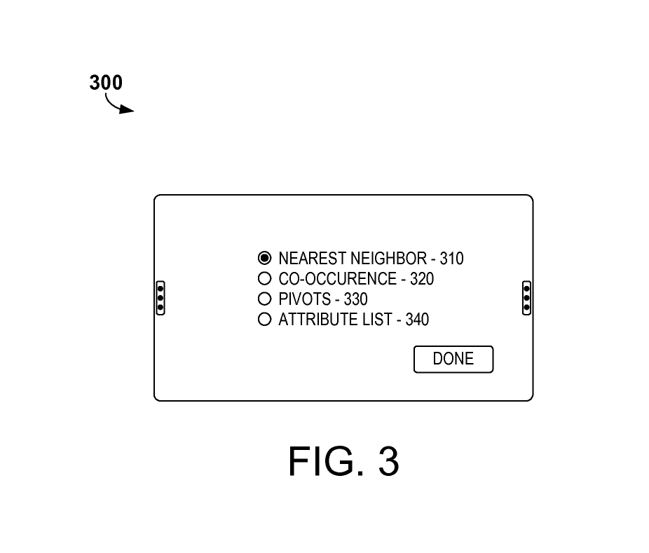

FIG. 3 is a screenshot illustrating an operations dialog box 300 for the dominant concepts in accordance with embodiments of the invention. The operations may include, but are not limited to, nearest neighbor 310, co-occurrence 320, pivots 330, and attribute list 340. The nearest neighbor operation 310 updates the graphical user interface with additional dominant concepts that are similar to a selected dominant concept. The co-occurrence operation 320 updates the graphical user interface with additional dominant concepts that occur in close proximity to a selected dominant concept or the contextual query. The pivots operation 330 provides lateral concepts for a selected dominant concept or the contextual query. The attribute list operation 340 provides information about the attributes corresponding to the contextual query or the dominant concept. The attributes may include, title, age, school, height, among other things. In certain embodiments, the attribute information is displayed in a details section of the graphical user interface. Accordingly, a user may select any of the above operations to update the graphical user interface with at least one additional dominant concept or attribute detail for the displayed dominant concepts and contextual query.

In another embodiment, the sparkler may display as part of a results page returned by a search engine in response to contextual query. The results page includes a search box listing the query terms of the contextual query, a results section that clusters the search results by source, and a sparkler control that includes the contextual query and its corresponding dominant concepts.

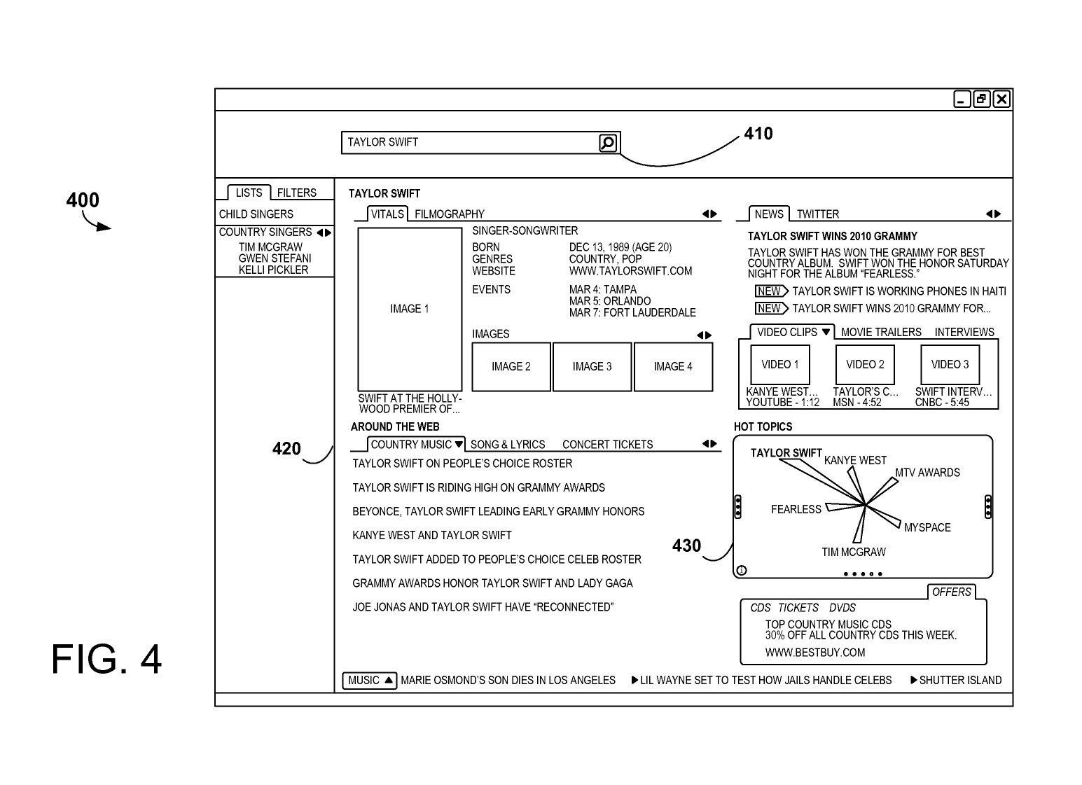

FIG. 4 is another screenshot illustrating a graphical user interface 400 displaying dominant concepts along with search results in accordance with embodiments of the invention. The graphical user interface 400 includes a search box 410, a results area 420, and a sparkler control 430. The search box 410 receives the contextual query from a user. In turn, the results area 420 displays the search results returned by a search engine that received the contextual query. In one embodiment the results area 420 lists all search results that correspond to the contextual query in rank order. In another embodiment, the results area 420 clusters the results based on source. For instance, results from news sources, twitter sources, web sources, etc., are grouped together and displayed simultaneously on the graphical user interface 400. The search results and the sparkler control 430 are displayed simultaneously in the graphical user interface 400. The sparkler control 430 allows the user to navigate the results and provides an overview of the broad concepts included in the search results.

For example, a search for “TAYLOR SWIFT” causes the search engine to provide a graphical user interface 400 having the results and a sparkler control as discussed above. The user may interact with the results or the sparkler control to review results. The graphical user interface 400 displayed the “TAYLOR SWIFT” search results with the “TAYLOR SWIFT” sparkler control.

Additionally, in another embodiment the sparkler control may be used to issue a contextual query to the search engine. The contextual query may include a dominant concept included in the sparkler control. In other words, a user may click on the dominant concepts displayed by the sparkler control to issue a new query. In turn, the search engine provides new results and the sparkler control may be updated with a new contextual query and new dominant concepts corresponding to the new contextual query.

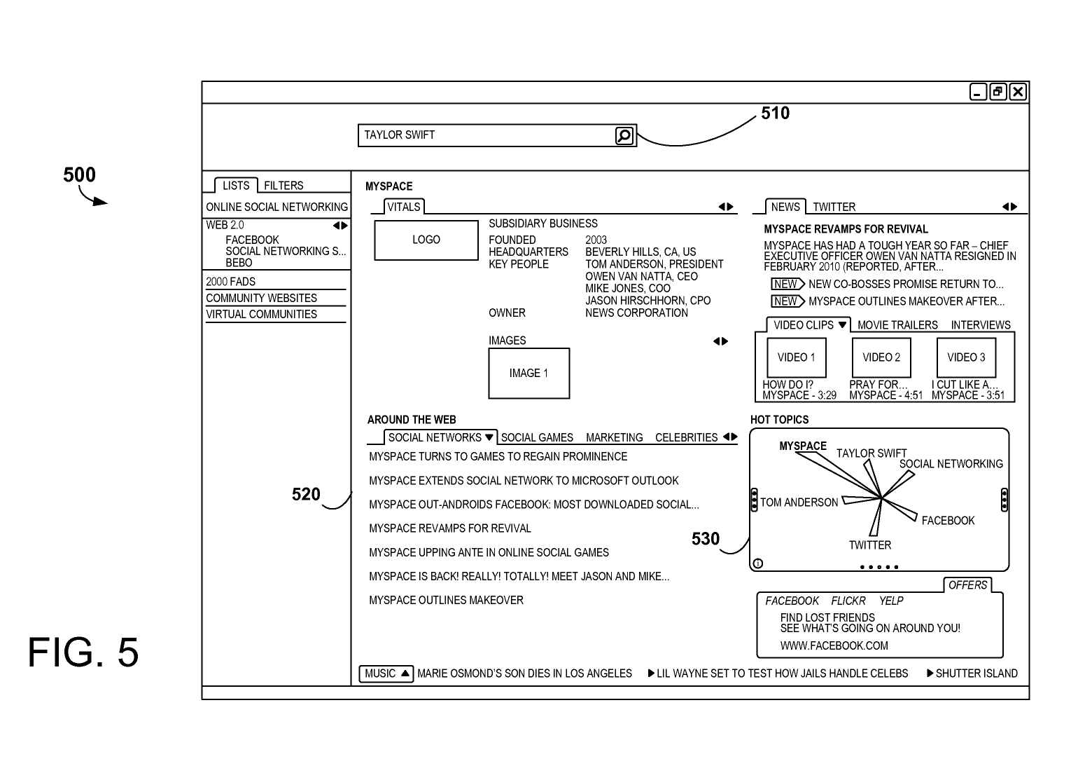

FIG. 5 is another screenshot illustrating a graphical user interface 500 transitioning dominant concepts and search results in accordance with embodiments of the invention. The graphical user interface 400 includes a search box 510, a results area 520, and a sparkler control 530. The search box 510 is updated to reflect the new contextual query selected by the user. The contextual query may be a previously displayed dominant concept. In turn, the results area 520 is updated to display the search results returned by a search engine that received the contextual query. In one embodiment the results area 520 is updated to list all search results that correspond to the contextual query in rank order. In another embodiment, the results area 520 is updated to cluster the results based on source. For instance, results from news sources, twitter sources, web sources, etc., are grouped together and displayed simultaneously on the graphical user interface 500. The search results and the sparkler control 530 are displayed simultaneously in the graphical user interface 500.

For example, a search for “TAYLOR SWIFT” caused the search engine to provide a graphical user interface 400 having the results and a sparkler control 430 as discussed above. The sparkler control 430 included a dominant concept “MYSPACE.” When the user clicked on the dominant concept “MYSPACE” the graphical user interface 400 was updated to reflect the new contextual query “MYSPACE” as illustrated by graphical user interface 500. Also, as shown in graphical user interface 500, the sparkler control 430 was also updated based on the search results for “MYSPACE” as illustrated by sparkler control 530.

In some embodiments, a computer system executes a computer-implemented method to navigate the dominant concepts. The dominant concepts are displayed in a graphical user interface generated by a search engine. The dominant concepts may be displayed in a graph control to provide an overview of the search results. In turn, the graphical user interface is updated based on the interactions with the graph control.

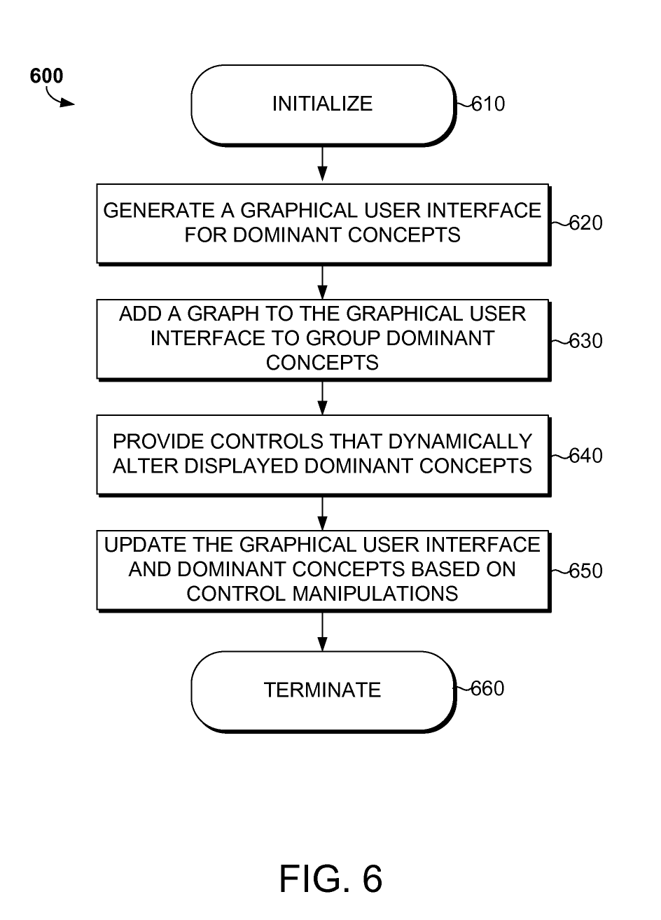

FIG. 6 is a logic diagram 600 illustrating a computer-implemented method for navigating dominant concepts in accordance with embodiments of the invention. The method initializes when a contextual query is received by a search engine in step 610. In one embodiment, the contextual query includes at least two of the following contextual attributes: query terms, location, time, and application. In step 620, the computer system generates a graphical user interface having dominant concepts associated with a contextual query issued to a search engine that searches multiple sources to locate results. In certain embodiments, the multiple sources include, video, web, audio, images, and social networking sources.

The dominant concepts are extracted from the results returned by the search engine. In step 630, the computer system adds a graph to the graphical user interface to group the dominant concepts extracted from the results. In one embodiment, hovering over a dominant concept in the graph causes a dialog box to be displayed, wherein the dialog box allows the user to further explore the dominant concept or to initiate a new search.

The graph links the contextual query and the dominant concepts. The graph is a sparkler that has a star shape with multiple spokes and may be limited to 5 spokes. The graphical user interface may include a section that displays the results of the contextual query simultaneously with the graph for the dominant concepts. In one embodiment, the graph may be a control element displayed on the search result page. In another embodiment, the graph may be a toolbar configured in a web browser that transmitted the contextual query to the search engine.

The computer system also provides controls that dynamically alter dominant concepts displayed by the graphical user interface, in step 640. In step 650, the computer system updates the graphical user interface and the dominant concepts displayed based on control manipulations received from a user interacting with the graphical user interface. The controls include backward navigation and forward navigation.

In some embodiments, the controls include at least one of an attribute list operation that lists attributes for a selected dominant concept; a nearest neighbor operation that provides additional dominant concepts that are related to a selected dominant concept; a co-occurrence operation that provides additional dominant concepts that frequently occur with a selected dominant concept; or a pivots operation that provides words or phrases that represent orthogonal topics of a selected dominant concept. The method terminates in step 660.

In summary, dominant concepts are navigated by a computer system. The computer system generates a graphical user interface having the dominant concepts associated with a contextual query. The contextual query is issued to a search engine that searches multiple sources to locate results. The computer system extracts the dominant concepts from the results and provides a graph to group the dominant concepts. The graph is a control that links the contextual query and the dominant concepts and dynamically alters dominant concepts displayed by the graphical user interface. The graphical user interface and the dominant concepts may be displayed simultaneously.

Many different arrangements of the various components depicted, as well as components not shown, are possible without departing from the spirit and scope of the present invention. Embodiments of the invention have been described with the intent to be illustrative rather than restrictive. It is understood that certain features and subcombinations are of utility and may be employed without reference to other features and subcombinations and are contemplated within the scope of the claims. Not all steps listed in the various figures need be carried out in the specific order described.

The invention claimed is:

1. A computer implemented method to navigate dominant concepts extracted from multiple sources, the method comprising:
generating a graphical user interface having dominant concepts associated with a contextual query issued to a search engine that searches multiple sources to locate results, wherein the dominant concepts are extracted from the results returned by the search engine;
adding a graph to the graphical user interface to group the dominant concepts extracted from the results, wherein the graph links the contextual query and the dominant concepts;
providing controls that dynamically alter dominant concepts displayed by the graphical user interface; and
updating the graphical user interface and the dominant concepts displayed based on control manipulations.

2. The method of claim 1, wherein the contextual query includes at least two of the following contextual attributes: query terms, location, time, and application.

3. The method of claim 1, wherein the multiple sources include, video, web, audio, and social networking sources.

4. The method of claim 1, wherein the graph is a sparkler that has a star shape with multiple spokes.

5. The method of claim 4, wherein the graph is limited to 5 spokes.

6. The method of claim 1, wherein the graphical user interface comprises a section that displays the results of the query simultaneously with the graph of the dominant concepts.

7. The method of claim 6, wherein the graph is a control element displayed on the search result page.

8. The method of claim 6, wherein the graph is a toolbar configured in a web browser that transmitted the contextual query to the search engine.

9. The method of claim 1, wherein hovering over a dominant concept causes a dialog box to be displayed, wherein the dialog box allows the user to further explore the dominant concept or to initiate a new search.

10. The method of claim 1, wherein the controls include backward navigation and forward navigation.

11. The method of claim 1, wherein the controls include an attribute list operation that lists attributes for a selected dominant concept.

12. The method of claim 1, wherein the controls include a nearest neighbor operation that provides additional dominant concepts that are related to a selected dominant concept.

13. The method of claim 1, wherein the controls include a co-occurrence operation that provides additional dominant concepts that frequently occur with a selected dominant concept.

14. The method of claim 1, wherein the controls include a pivots operation that provides words or phrases that represent orthogonal topics of a selected dominant concept.

15. A graphical user interface generated by a computer system having processors and computer-readable media, wherein the graphical user interface provides dynamic views of dominant concepts extracted from multiple sources, the graphical user interface comprising:
a graph linking dominant concepts to a contextual query, wherein the dominant concepts are extracted from results provided by a search in response to receiving the contextual query; and
navigation controls that dynamically alter the dominant concepts displayed to the user.

16. The graphical user interface of claim 15, wherein the dominant concepts and contextual queries are links to views, wherein the contextual queries or dominant concepts are the contextual query.

17. The graphical user interface of claim 15, wherein the backward navigation control and forward navigation control causes sliding animation that brings an additional view from left-to-right when moving backward, or right-to-left when moving forward.

18. The graphical user interface of claim 15, wherein an ellipsis control at the bottom of the graph control allows the user to move nonsequentially to any view in the view navigation history.

19. The graphical user interface of claim 15, wherein hovering over a dominant concept causes a dialog box to be displayed, wherein the dialog box allows the user to further explore the dominant concept hovered over or to initiate a new search.

20. One or more computer-readable media storing computer-usable instructions for performing a method to navigate dominant concepts extracted from multiple sources, the method comprising:
generating a graphical user interface having dominant concepts associated with a contextual query issued to a search engine that searches multiple sources to locate results, wherein the dominant concepts are extracted from the results returned by the search engine;
adding a graph to the graphical user interface to group the dominant concepts extracted from the results, wherein the graph links the contextual query and the dominant concepts;
providing controls that dynamically alter dominant concepts displayed by the graphical user interface; and
updating the graphical user interface and the dominant concepts displayed based on control manipulations.
